(19) United States
(12) Patent Application Publication
(10) Pub. No.: US 2025/0180190 A1
(43) Pub. Date: Jun. 5, 2025

(54) LIGHT SOURCE DEVICE AND PROJECTOR

(71) Applicant: Sharp NEC Display Solutions, Ltd., Tokyo (JP)

(72) Inventor: Yusuke TANI, Tokyo (JP)

(21) Appl. No.: 19/049,158

(22) Filed: Feb. 10, 2025

Related U.S. Application Data
(63) Continuation of application No. PCT/JP2022/034263, filed on Sep. 13, 2022.

(51) Int. Cl. F21V 17/12; F21V 29/76; G03B 21/16; G03B 21/20

(52) U.S. Cl. CPC F21V 17/12; F21V 29/763; G03B 21/16; G03B 21/2033; G03B 21/2046

(57) ABSTRACT

A light source device includes a light source having at least a first positioning hole; a heat radiator that has a placement surface on which the light source is placed, the heat radiator that has at least a second positioning hole on the placement surface; a pressing member configured to press the light source against the placement surface; and a fixing member that fixes the pressing member to the heat radiator, while the pressing member pressing the light source against the placement surface. The pressing member has at least a first positioning pin inserted into the at least first positioning hole of the light source, and at least a second positioning pin inserted into the at least second positioning hole on the placement surface of the heat radiator.

### TECHNICAL FIELD

The present disclosure relates to a light source device and a projector.

### BACKGROUND ART

Patent Document 1 discloses a projector (a projection type video display device) including a light source device having a light source (a semiconductor laser). In the light source device of Patent Document 1, the light source is placed on a placement surface of a heat radiator (a holding section). In addition, in the light source device of Patent Document 1, a positioning pin (a protrusion section) protruding from the placement surface is used to position the light source on the placement surface.

### CITATION LIST

### Patent Literature

### Patent Literature 1

Japanese Unexamined Patent Application, First Publication No. 2020-071379

### SUMMARY OF INVENTION

### Technical Problem

However, when a convex such as a positioning pin is formed on the placement surface of the heat radiator, a shape of the heat radiator becomes complicated, which increases the manufacturing costs of the heat radiator and the light source device containing it.

In addition, when the light source is inserted into the positioning pin protruding from the placement surface of the heat radiator and placed on the placement surface, if the light source is removed from the heat radiator, the light source needs to be moved in a direction orthogonal to the placement surface. However, when thermally conductive grease is interposed between the light source and the heat radiator to efficiently release heat from the light source to the heat radiator, surface tension due to the grease acts between the light source and the placement surface. For this reason, it becomes difficult to separate the light source from the placement surface in a direction orthogonal to the placement surface. That is, a problem arises in that it is difficult to remove the light source from the heat radiator.

The present invention has been made in view of the circumstances described above, and an object thereof is to provide a light source device and a projector that can reduce manufacturing costs while enabling positioning of a light source on a placement surface, and that can also make it easy to remove the light source from a heat radiator.

### Solution to Problem

According to a first aspect of the present invention, a light source device includes a light source, a heat radiator that has a placement surface on which the light source is placed, a pressing member configured to press the light source against the placement surface, and a fixing member that fixes the pressing member to the heat radiator with the light source pressed against the placement surface by the pressing member. The pressing member has a first positioning pin inserted into a first positioning hole formed in the light source, and a second positioning pin inserted into a second positioning hole formed on the placement surface.

According to a second aspect of the present invention, there is a projector that has the light source device.

### Advantageous Effects of Invention

According to the present invention, the manufacturing costs of a light source device can be reduced while a light source can be positioned on a placement surface of a heat radiator, and the light source can be easily removed from the heat radiator.

### BRIEF DESCRIPTION OF DRAWINGS

FIG. 1 is a perspective view which shows an appearance of a projector according to an embodiment of the present invention.

FIG. 2 is a perspective view of the projector shown in FIG. 1, which shows a state in which an upper cover of a housing is removed.

FIG. 3 is a perspective view which shows positions of a light source device and a blower fan on a bottom plate of the housing in FIG. 2.

FIG. 4 is a perspective view which shows the light source device and the blower fan in FIGS. 1 to 3.

FIG. 5 is a cross-sectional view which shows a relationship between a heat radiator and an optical system in the light source device of FIG. 4.

FIG. 6 is a cross-sectional view which shows the relationship between the heat radiator and the optical system in the light source device of FIG. 4.

FIG. 7 is a perspective view of the light source device shown in FIG. 4 in which a state where the heat radiator and the optical system are separated is viewed from a placement surface side.

FIG. 8 is a perspective view in which the state shown in FIG. 7 is viewed from a different direction.

FIG. 9 is a front view of the light source device shown in FIG. 7, in which a light source, a heat radiator, and a pressing member are viewed from the placement surface side.

FIG. 10 is a cross-sectional view which shows a relationship among the light source, the heat radiator, and the pressing member in a configuration of FIG. 9.

FIG. 11 is an enlarged view of a section XI in FIG. 10.

FIG. 12 is a cross-sectional view which shows the relationship among the light source, the heat radiator, and the pressing member in the configuration of FIG. 9.

FIG. 13 is a perspective view of the configuration shown in FIG. 9, in which a state where the light source, the heat radiator, and the pressing member are separated is viewed from the placement surface side.

FIG. 14 is a perspective view in which the state shown in FIG. 13 is viewed from a different direction.

### DESCRIPTION OF EMBODIMENTS

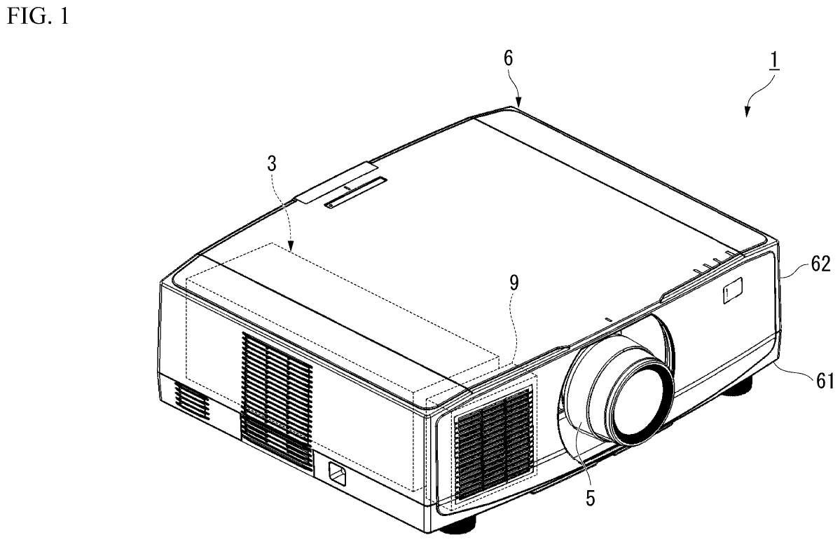

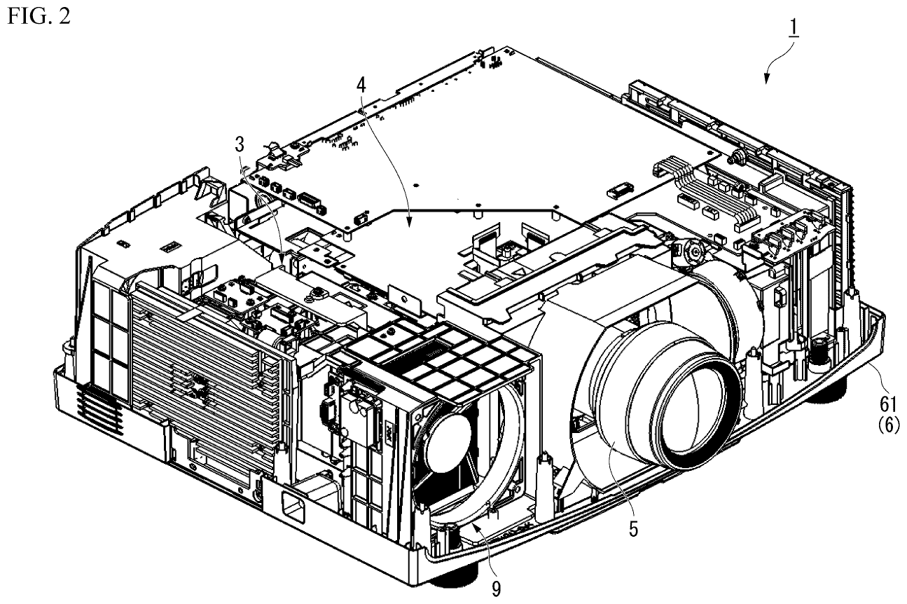

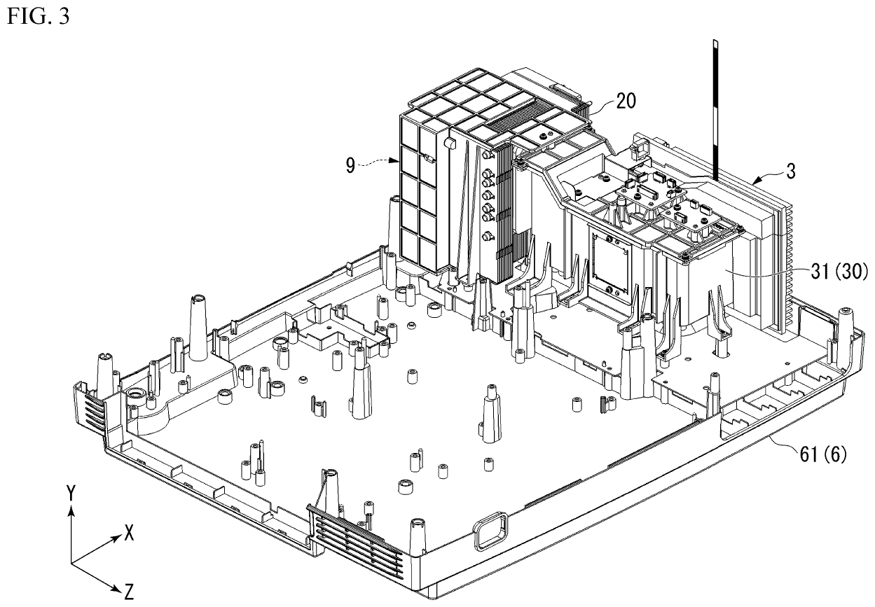

Some embodiments of the present invention will be described below with reference to FIGS. 1 to 14.

As shown in FIGS. 1 to 3, a projector 1 according to the present embodiment is a device that projects image light (a video) onto a display surface such as a screen. The projector 1 includes a light source device 3, an image light forming device 4, a projection device 5, a housing 6, and a blower fan 9.

The image light forming device 4 creates image light on the basis of light output from the light source device 3, which will be described below. Although not shown, the image light forming device 4 includes a light modulation device such as a digital micromirror device (DMD) or a liquid crystal panel, an electronic component for controlling the light modulation device, and the like.

The projection device 5 magnifies the image light output from the image light forming device 4 and projects it onto a display surface such as a screen.

The housing 6 houses the light source device 3, the image light forming device 4, the projection device 5, and the blower fan 9. The housing 6 includes a bottom plate 61 on which a light source device 3, an image light forming device 4, a projection device 5, and a blower fan 9 are placed, and an upper cover 62 that covers the light source device 3, the image light forming device 4, the projection device 5, and the blower fan 9 from above.

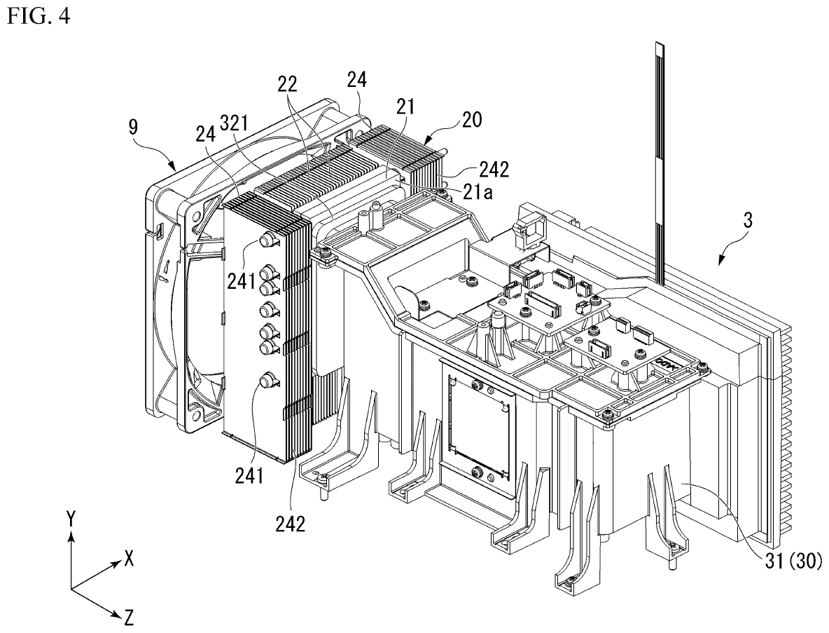

As shown in FIGS. 4 and 7, the light source device 3 includes a light source 10, a heat radiator 20, an optical system 30, and a pressing member 40.

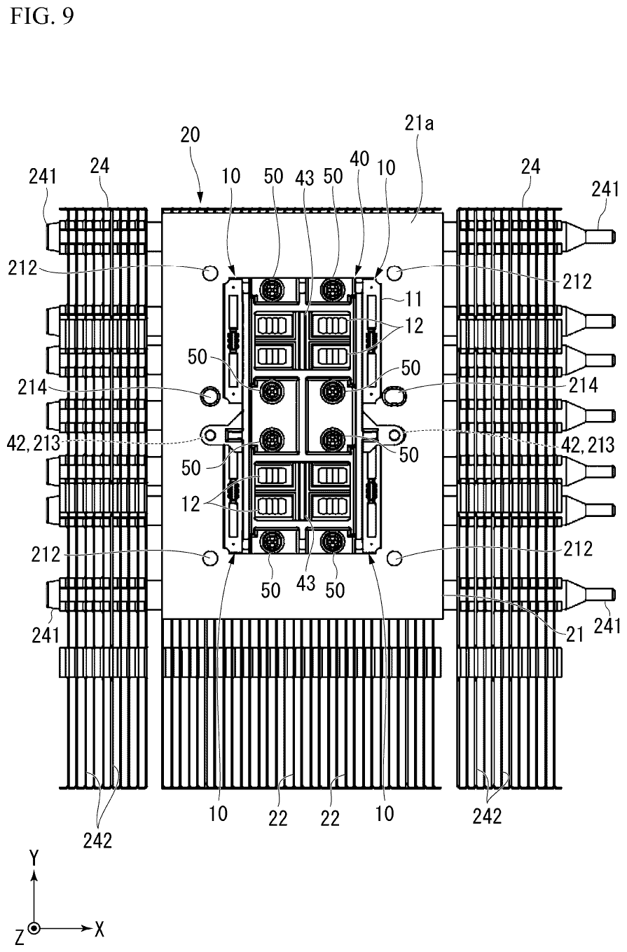

The light source 10 emits light. As shown in FIGS. 7 and 9, the light source device 3 of the present embodiment has a plurality of light sources 10. As shown in FIGS. 9 to 13, each light source 10 includes a substrate 11 and a light-emitting element 12 mounted on the substrate 11.

Although the light-emitting element 12 may be, for example, a light-emitting diode (LED), it is a laser diode in the present embodiment. That is, the light source 10 of the present embodiment is a laser substrate. The light-emitting element 12 may be, for example, a blue semiconductor element that emits laser light in a blue wavelength range, or a red semiconductor element that emits laser light in a red wavelength range. The blue semiconductor device has a relatively high heat-resistance temperature and a relatively large heat generation amount. The red semiconductor device has a lower heat-resistance temperature and a smaller heat generation amount than the blue semiconductor device. The number of the light-emitting elements 12 included in the light source 10 may be two as shown in the shown example, but is not limited to this.

As shown in FIGS. 9, 13, and 14, the heat radiator 20 is for cooling the light source 10, and includes a heat radiation board 21, a plurality of heat radiation fins 22, and an extended heat radiator 24.

As shown in FIGS. 9 to 13, the heat radiation board 21 is formed generally flat and has a placement surface 21a on which a plurality of light sources 10 are placed. Specifically, the substrate 11 of the light source 10 is disposed to overlap the placement surface 21a. Although the substrate 11 may be in direct contact with the placement surface 21a, for example, thermally conductive grease may be interposed between the substrate 11 and the placement surface 21a to improve heat transfer from the substrate 11 to the heat radiation board 21. The heat radiation board 21 is made of a highly conductive material such as copper or aluminum.

In FIGS. 4 to 14, a first direction along the placement surface 21a of the heat radiation board 21 is indicated as an X-axis direction, and a second direction orthogonal to the first direction along the placement surface 21a is indicated as a Y-axis direction. Moreover, an orthogonal direction orthogonal to the placement surface 21a is shown as a Z-axis direction. The Z-axis direction corresponds to a thickness direction of the heat radiation board 21.

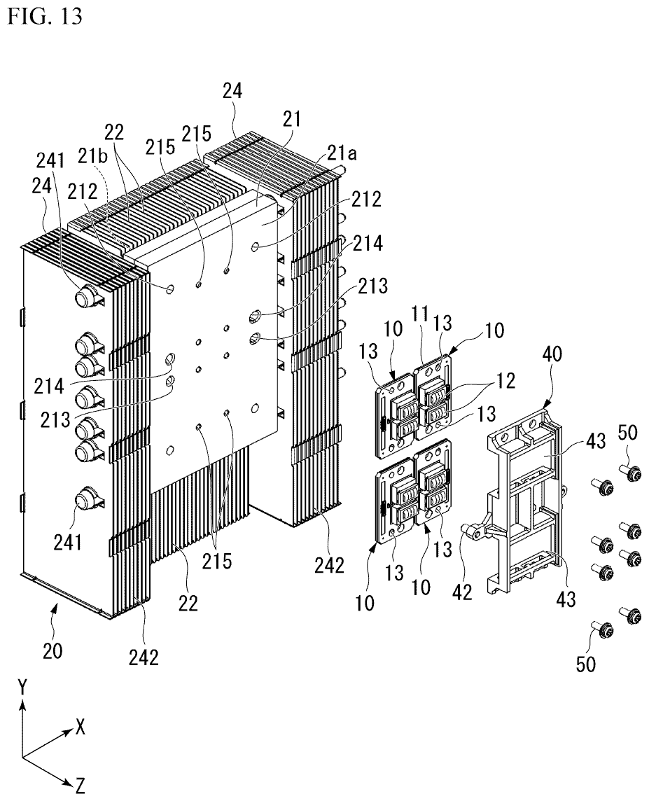

As shown in FIGS. 9 and 13, in the present embodiment, the number of the light sources 10 placed on the placement surface 21a of the heat radiation board 21 is four. In addition, these four light sources 10 are placed on the placement surface 21a so that two of them are lined up in the first direction and two of them are lined up in the second direction. Note that the number of the light sources 10 placed on the placement surface 21a and an array of the plurality of light sources 10 (for example, the number of the light sources 10 lined up in the first direction and the second direction) may be arbitrary.

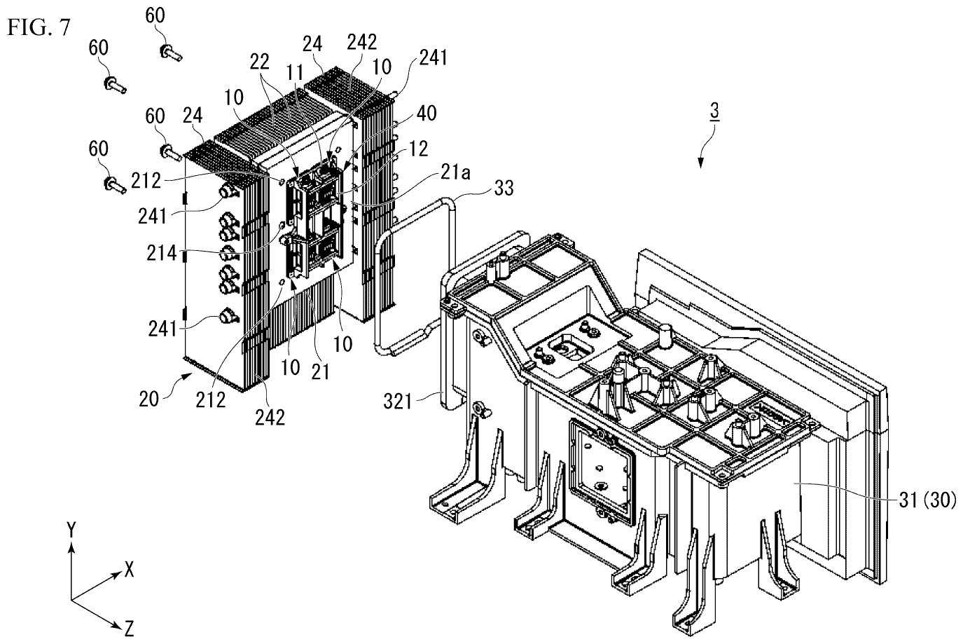

As shown in FIG. 6, the heat radiation board 21 of the present embodiment has a plurality of concave sections 211 recessed from a back surface 21b of the heat radiation board 21 facing opposite to the placement surface 21a in the thickness direction. Moreover, a plurality of through holes 212 are formed in the heat radiation board 21, which penetrate from a bottom surface of each concave section 211 to the placement surface 21a. A fixing screw 60 for fixing an optical system 30, which will be described below, to the heat radiation board is inserted into each through hole 212 from a back surface side 21b.

As shown in FIGS. 6, 13, and 14, the plurality of heat radiation fins 22 are provided on the back surface 21b of the heat radiation board 21. The plurality of heat radiation fins 22 are each formed into a plate shape whose thickness direction is the first direction (the X-axis direction) along the placement surface 21a of the heat radiation board 21, and are lined up at intervals in the first direction. The plurality of heat radiation fins 22 protrude only to one side (a Y-axis negative direction side) of the heat radiation board 21 in the second direction (the Y-axis direction), but they may protrude to, for example, both sides of the heat radiation board 21, or may not protrude, for example.

The plurality of heat radiation fins 22 provided on the back surface 21b of the heat radiation board 21 are formed avoiding a part of the back surface 21b so that the concave section 211 and the through hole 212 of the heat radiation board 21 described above are exposed on the back surface 21b side.

As shown in FIGS. 9, 13, and 14, the extended heat radiators 24 are positioned on both sides of the heat radiation board 21 in the first direction. Note that the extended heat radiator 24 may be, for example, positioned only on one side of the heat radiation board 21 in the first direction.

The extended heat radiator 24 includes a heat pipe 241 and a plurality of heat radiation fins 242 attached to the heat pipe 241. The heat pipe 241 penetrates the heat radiation board 21 in the first direction and extends from both ends of the heat radiation board 21. A plurality of heat pipes 241 (seven in the shown example) are lined up in the second direction.

The plurality of heat radiation fins 242 of the extended heat radiator 24 are each formed in a plate shape with the thickness direction being the first direction. The plurality of heat radiation fins 242 are lined up at intervals in the first direction on both sides of the heat radiation board 21 in the first direction. The heat pipe 241 is attached to the plurality of heat radiation fins 242 to penetrate through the heat radiation fins 242 in the thickness direction thereof.

In the heat radiator 20, air can be caused to flow between adjacent heat radiation fins 22 and 242 by flowing air in an orthogonal direction (the Z-axis direction) to the plurality of heat radiation fins 22 and extended heat radiators 24. As a result, it is possible to dissipate heat transmitted from the plurality of light sources 10 to the heat radiation fin 22 via the heat radiation board 21 and heat transmitted to the plurality of heat radiation fins 242 via the heat radiation board 21 and heat pipe 241, that is, it is possible to cool the plurality of light sources 10.

As shown in FIGS. 9 to 14, the pressing member 40 presses the light source 10 against the placement surface 21a of the heat radiation board 21. In the present embodiment, the pressing member 40 presses the plurality of light sources 10 all at once against the placement surface 21a. In addition, the pressing member 40 does not press the light-emitting element 12 of each light source 10 against the placement surface 21a, but presses the substrate 11 of each light source 10 against the placement surface 21a. The pressing member 40 has a first positioning pin 41 and a second positioning pin 42.

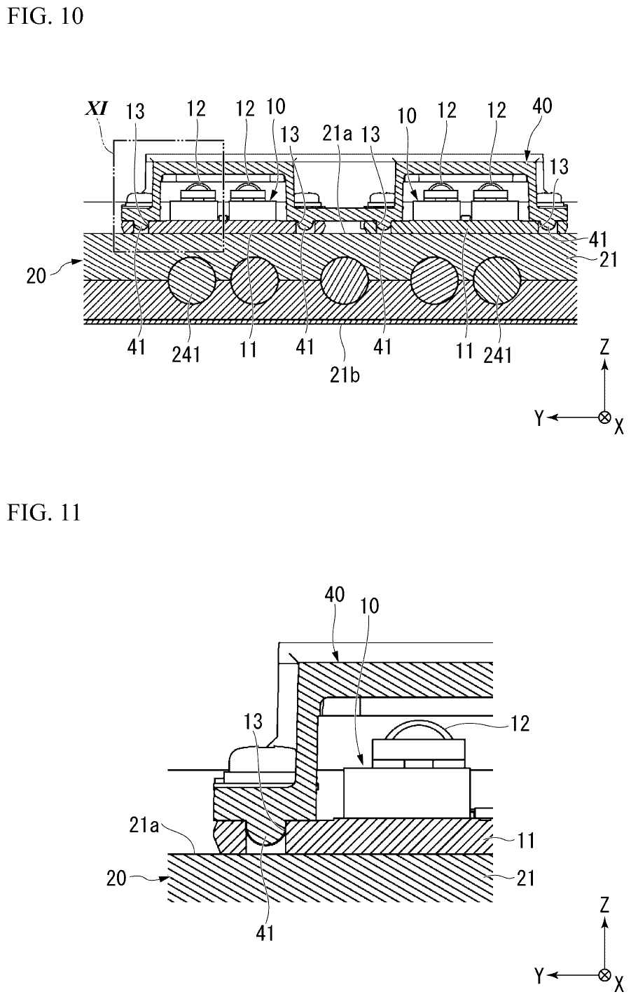

As shown in FIGS. 10, 11, and 14, the first positioning pin 41 is inserted into the first positioning hole 13 formed in the light source 10. In the present embodiment, the first positioning hole 13 is formed to penetrate the substrate 11 in its thickness direction. Note that the first positioning hole 13 does not need to penetrate, for example, the substrate 11.

The first positioning pin 41 protrudes from a surface of the pressing member 40 that is pressed against the substrate 11. The first positioning pin 41 may be formed, for example, in a columnar shape, but it is formed in a hemispherical shape in the present embodiment. A radius of the first positioning pin 41 formed in a hemispherical shape is smaller than a thickness of the substrate 11. As a result, it is possible to prevent the first positioning pin 41 inserted into the first positioning hole 13 of the substrate 11 from penetrating the substrate 11 and protruding to an outside of the substrate 11.

The number of first positioning pins 41 for the same light source 10 may be, for example, three or more, but it is two in the present embodiment. By having a plurality of first positioning pins 41 corresponding to the same light source 10, rotation and displacement of the light source 10 pressed against the placement surface 21a by the pressing member 40 can be suppressed or prevented.

The number of the first positioning pins 41 formed in the pressing member 40 corresponds to the number of the light sources 10 pressed against the placement surface 21a by the pressing member 40. The number of the first positioning pins 41 in the pressing member 40 of the shown example is twice the number of the light sources 10.

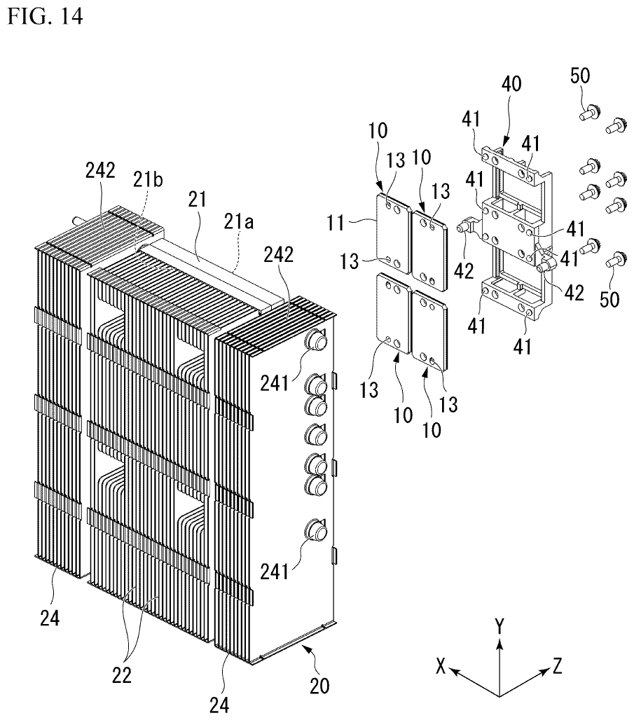

As shown in FIGS. 9, 12, and 13, the second positioning pin 42 is inserted into the second positioning hole 213 formed on the placement surface 21a of the heat radiation board 21. The number of the second positioning pins 42 and the corresponding second positioning holes 213 may be, for example, three or more, but it is two in the present embodiment. By having a plurality of second positioning pins 42, it is possible to suppress or prevent the pressing member 40 from being misaligned with respect to the placement surface 21a of the heat radiation board 21. As shown in FIGS. 13 and 14, the second positioning hole 213 and the corresponding second positioning pin 42 have a circular shape in a view from the placement surface 21a side.

The second positioning pin 42 is positioned outside an area in which the plurality of light sources 10 are placed on the placement surface 21a of the heat radiation board 21. Specifically, two of the second positioning pins 42 are positioned on both sides of the plurality of light sources 10 placed on the placement surface 21a in the first direction (the X-axis direction) along the placement surface 21a.

As shown in FIGS. 9, 12, and 13, the pressing member 40 described above is fixed to the heat radiation board 21 (heat radiator 20) by a fixing member 50 with the light source 10 pressed against the placement surface 21a by the pressing member 40. In the present embodiment, the fixing member 50 is a male screw that is screwed into a female screw 215 formed on the heat radiation board 21 with the pressing member 40 and the substrate 11 of the light source 10 sandwiched between the fixing member 50 and the placement surface 21a. In the shown example, the number of fixing members 50 corresponding to each light source 10 is two, but it is not limited to this. It may be, for example, three or more, or it may also be one. When the number of fixing members 50 corresponding to the same light source 10 is plural, the light source 10 pressed by the pressing member 40 can be stably fixed to the heat radiation board 21.

Furthermore, a plurality of fixing members 50 corresponding to the same light source 10 penetrate the same light source 10. Thereby, it is possible to suppress or prevent fixation of the light source 10 by the plurality of fixing members 50 from being suddenly canceled.

In addition, the number of fixing members 50 corresponding to the same light source 10 is the same as the number of first positioning pins 41 of the pressing member 40 corresponding to the same light source 10. Furthermore, the plurality of fixing members 50 corresponding to each light source 10 (a predetermined light source 10) are positioned adjacent to the plurality of first positioning pins 41 corresponding to each light source 10, respectively. In the shown example, the fixing member 50 and the first positioning pin 41 that correspond to each other are adjacent to each other in the first direction (the X-axis direction).

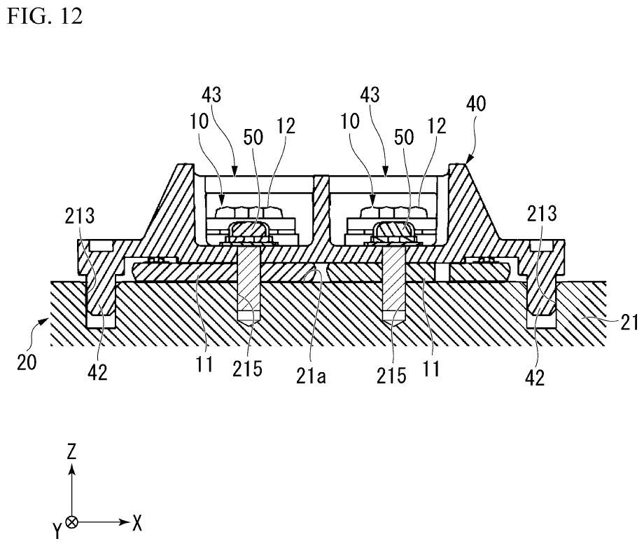

As shown in FIGS. 9 and 12, the pressing member 40 is provided to sandwich the light source 10 between it and the placement surface 21a of the heat radiation board 21, but does not inhibit light emitted from the light-emitting element 12 of the light source 10. Specifically, an exposure hole 43 that exposes the light-emitting element 12 in a direction away from the placement surface 21a (a positive direction of the Z-axis) is formed in the pressing member 40.

A thermal conductivity of the pressing member 40 is preferably set in consideration of a heat-resistance temperature and a heat generation amount of the light-emitting element 12 of the light source 10.

For example, when the light-emitting element 12 has a high heat-resistance temperature (for example, higher than a temperature inside the case 31 of the optical system 30 described below) and a large heat generation amount, such as a blue semiconductor element, a thermal conductivity of the pressing member 40 is preferably high. That is, the pressing member 40 is preferably made of, for example, a material with high thermal conductivity, such as copper or aluminum. Due to the high thermal conductivity of the pressing member 40, the heat of the light-emitting element 12 is added to the heat radiator 20 and is also released to the pressing member 40, and can be dissipated from the pressing member 40 to a space on the placement surface 21a side of the heat radiation board 21 (a space inside the case 31).

On the other hand, when the light-emitting element 12 has a low heat-resistance temperature (for example, lower than the temperature inside the case 31 of the optical system 30) and a small heat generation amount, such as a red semiconductor element, the thermal conductivity of the pressing member 40 is preferably low. For example, the thermal conductivity of the pressing member 40 is preferably lower than the thermal conductivity of the heat radiation board 21 (the heat radiator 20). The thermal conductivity of the pressing member 40 is preferably, for example, one-tenth or less of the thermal conductivity of the heat radiation board 21.

Specifically, when the heat radiation board 21 is made of copper (thermal conductivity λ=380 W/(m·K)) or aluminum (thermal conductivity λ=220 W/(m·K)), the pressing member 40 may be a resin material or stainless steel. Examples of the resin material include, for example, polycarbonate (PC; thermal conductivity λ=0.2 to 0.4 W/(m·K)), polybutylene terephthalate (PBT; thermal conductivity λ=0.2 to 0.4 W/(m·K)), polyphenylene sulfide (PPS; thermal conductivity λ=0.2 to 0.4 W/(m·K)), liquid crystal polymer (LCP; thermal conductivity λ=0.3 to 0.6 W/(m·K)), and the like. Moreover, examples of the stainless steel include, for example, SUS304 (thermal conductivity λ=16 W/(m·K)).

Since thermal conductivity of the pressing member 40 is lower than that of the heat radiation board 21, heat of the light source 10 (the light-emitting element 12) can be actively released to the heat radiation board 21 side, and heat in a space on the placement surface 21a side (a space inside the case 31) can be suppressed from being transmitted to the light source 10 via the pressing member 40. As a result, even if the temperature of the space on the placement surface 21a side is higher than a heat-resistance temperature of the light source 10, the light source 10 can be thermally protected by the pressing member 40.

As shown in FIGS. 4 to 8, the optical system 30 is attached to the placement surface 21a of the heat radiation board 21 where the light source 10 is placed. The optical system 30 appropriately processes light (blue light and red light) from the light source 10 and outputs white light to the image light forming device 4. The optical system 30 includes a plurality of optical system parts (not shown) for appropriately processing the light from the light source 10, and the case 31 that houses these optical system parts.

The case 31 of the optical system 30 has an opening 32 that allows the light emitted from the light source 10 to be incident on an inside of the case 31. An edge 321 of the opening 32 of the case 31 is in close contact with an area around the light source 10 and the pressing member 40 of the placement surface 21a. Specifically, the edge 321 of the opening 32 of the case 31 is provided with an elastic body 33 such as an O-ring. By pressing this elastic body 33 against the placement surface 21a, the edge 321 of the opening 32 of the case 31 can be brought into close contact with the placement surface 21a without any gap. When the edge 321 of the opening 32 of the case 31 is in close contact with the placement surface 21a, the light source 10 placed on the placement surface 21a is covered by the case 31. As a result, dust on an outside of the case 31 can be suppressed or prevented from reaching the light source 10.

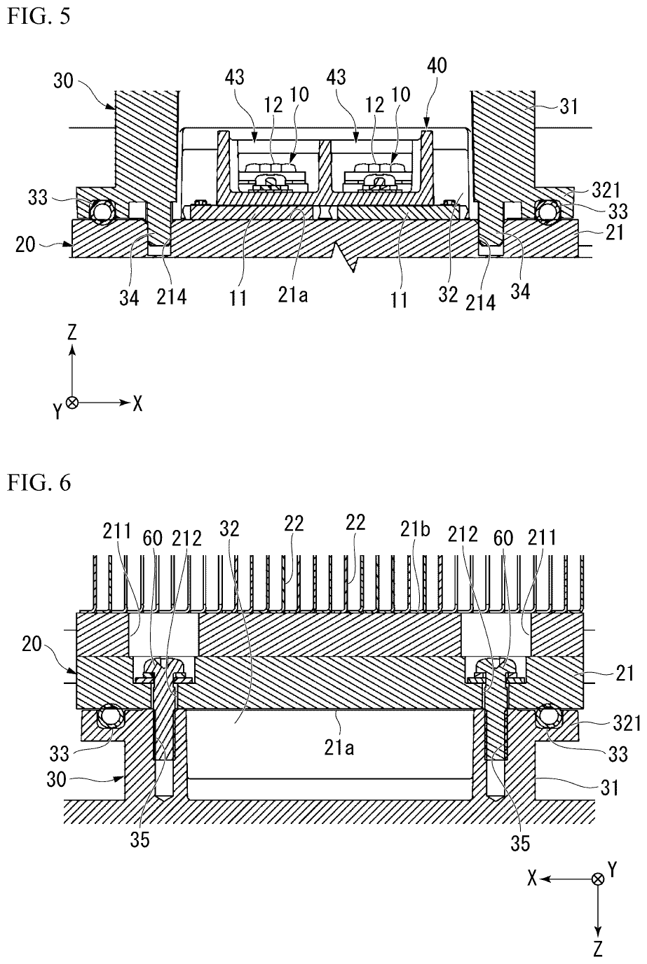

As shown in FIGS. 5, 7, and 8, the case 31 has a third positioning pin 34 inserted into a third positioning hole 214 formed on the placement surface 21a of the heat radiation board 21. The third positioning pin 34 is provided at the edge 321 of the opening 32 of the case 31. The third positioning pin 34 is disposed inside an installation location of the elastic body 33 in the edge 321 of the opening 32 so as not to interfere with the elastic body 33 described above. The number of third positioning pins 34 and corresponding third positioning holes 214 may be, for example, three or more, but it is two in the present embodiment. Since the number of third positioning pins 34 is plural, it is possible to suppress or prevent the optical system 30 including the case 31 from being misaligned with respect to the placement surface 21a of the heat radiation board 21.

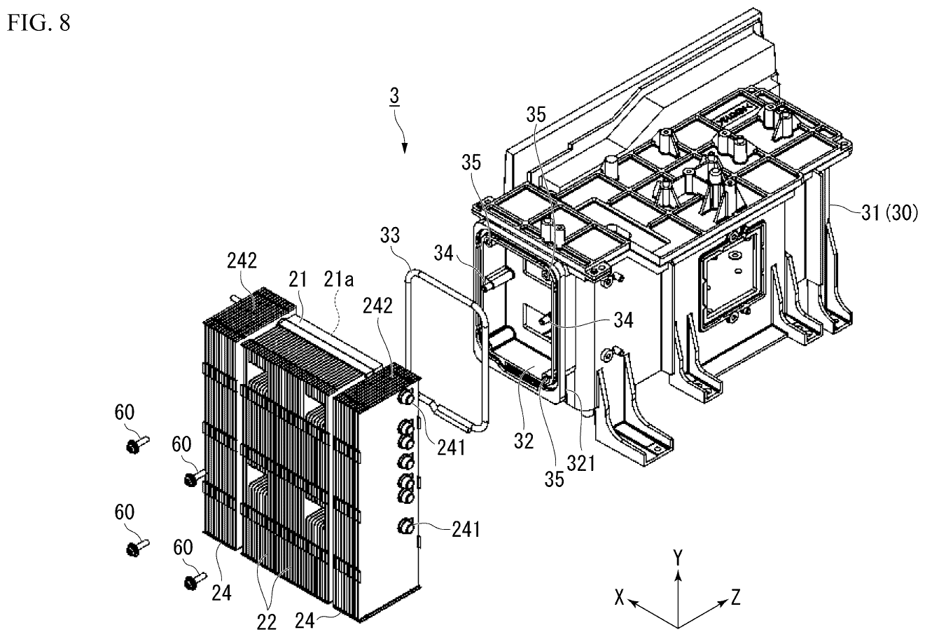

As shown in FIGS. 8 and 9, shapes of the third positioning hole 214 and the corresponding third positioning pin 34 in a view from the placement surface 21a side are circular. The shape of the third positioning hole 214 viewed from the placement surface 21a side is circular the same as that of the second positioning hole 213 described above, but sizes of the second positioning hole 213 and the third positioning hole 214 are different from each other. In the present embodiment, the size of the third positioning hole 214 is larger than the size of the second positioning hole 213, but the present invention is not limited to this.

As shown in FIGS. 6 and 8, the case 31 of the optical system 30 has a female screw hole 35. A fixing screw 60 for fixing the case 31 to the placement surface 21a of the heat radiation board 21 is screwed into the female screw hole 35. The female screwed hole 35 is disposed at a position on the edge 321 of the opening 32 of the case 31 so as not to interfere with the installation location of the elastic body 33 and the third positioning pin 34. The edge 321 of the opening 32 of the case 31 can be held in close contact with the placement surface 21a by screwing the fixing screw 60 into the female screw hole 35 of the case 31 when the heat radiation board 21 is sandwiched between the fixing screw 60 and the case 31.

As shown in FIG. 4, the blower fan 9 is disposed to face the heat radiation board 21 via a plurality of heat radiation fins 22, and also to face the extended heat radiator 24. The blower fan 9 blows air toward the plurality of heat radiation fins 22 and the extended heat radiators 24 in an orthogonal direction (the Z-axis direction). By blowing air from the blower fan 9, the plurality of light sources 10 can be cooled by causing air to pass through between the adjacent heat radiation fins 22 and 242.

In the light source device 3 of the present embodiment and the projector 1 including the same, the first positioning pin 41 of the pressing member 40 is inserted into the first positioning hole 13 of the light source 10, so that the light source 10 is positioned with respect to the pressing member 40. In addition, by inserting the second positioning pin 42 of the pressing member 40 into the second positioning hole 213 of the heat radiator 20, the pressing member 40 is positioned with respect to the heat radiator 20. As a result, the light source 10 can be positioned with respect to the placement surface 21a of the heat radiator 20 via the pressing member 40. Therefore, even if the heat radiator 20 is free of a convex such as a positioning pin protruding from the placement surface 21a, the light source 10 can be positioned at a predetermined position on the placement surface 21a.

Moreover, when the pressing member 40 presses the light source 10 against the placement surface 21a of the heat radiator 20, the pressing member 40 is fixed to the heat radiator 20 by the fixing member 50, so that the light source 10 can be fixed to the placement surface 21a via the pressing member 40.

Since no convex such as a positioning pin is formed on the placement surface 21a of the heat radiator 20, a shape of the heat radiator 20 (particularly a shape of the placement surface 21a) can be simplified. Therefore, the manufacturing costs of the light source device 3 including the heat radiator 20 can be reduced.

Moreover, the light source 10 is positioned on the placement surface 21a of the heat radiator 20 via the pressing member 40. For this reason, even if the light source 10 is disposed on the placement surface 21a via thermally conductive grease, the light source 10 can be easily removed from the heat radiator 20. To describe this point, when the light source 10 is removed from the heat radiator 20, after the pressing member 40 is removed from the heat radiator 20, the light source 10 can be removed from the edge of the placement surface 21a by moving it along the placement surface 21a. As a result, even if surface tension based on the thermally conductive grease acts between the light source 10 and the placement surface 21a, the light source 10 can be easily removed from the heat radiator 20.

Furthermore, in the light source device 3 of the present embodiment and the projector 1 including the same, the optical system 30 has a third positioning pin 34 inserted into the third positioning hole 214 formed on the placement surface 21a of the heat radiator 20. As a result, the optical system 30 can be positioned with respect to the heat radiator 20 without forming pins for positioning the optical system 30 on the placement surface 21a of the heat radiator 20.

Furthermore, in the light source device 3 of the present embodiment and the projector 1 including the same, the sizes of the second positioning hole 213 and the third positioning hole 214 in a view from the placement surface 21a side are different from each other. As a result, erroneous insertion of the second positioning pin 42 of the pressing member 40 and the third positioning pin 34 of the optical system 30 into the second and third positioning holes 213 and 214 of the heat radiator 20 can be suppressed or prevented.

Moreover, in the light source device 3 of the present embodiment and the projector 1 including the same, the pressing member 40 is configured to press the plurality of light sources 10 at once against the placement surface 21a. In addition, the pressing member 40 has a plurality of first positioning pins 41 corresponding to the plurality of light sources 10, respectively. For this reason, it is sufficient to prepare only one pressing member 40 for the plurality of light sources 10 placed on the placement surface 21a of the heat radiator 20. As a result, the number of components of the light source device 3 can be reduced, and the manufacturing costs of the light source device 3 and the projector 1 can be reduced.

Furthermore, in the light source device 3 of the present embodiment and the projector 1 including the same, the first positioning pin 41 is formed in a hemispherical shape. For this reason, even if a thickness of the substrate 11 (the light source 10) is smaller than when the first positioning pin 41 is formed in a columnar shape, the first positioning pin 41 can be easily inserted into the first positioning hole 13 of the light source 10, and the light source 10 can be positioned with higher accuracy with respect to the pressing member 40. Specifically, since the first positioning pin 41 is guided inside the first positioning hole 13 by a hemispherical surface of the first positioning pin 41, the first positioning pin can be easily inserted into the positioning insertion hole. Moreover, by making a hole diameter of the first positioning hole 13 corresponding to a diameter of the first positioning pin 41 which has a hemispherical shape, it is possible to position the light source 10 with respect to the pressing member 40 with high accuracy.

Although the embodiments of the present invention have been described above, the present invention is not limited to the embodiments described above, and can be modified as appropriate in a range not departing from the gist thereof.

In the present invention, for example, the shapes of the second positioning hole 213 and the third positioning hole 214 in a view from the placement surface 21a side may be different from each other, or both the shapes and sizes of the second positioning hole 213 and the third positioning hole 214 a view from the placement surface 21a side may be different from each other. Even with such a configuration, in the same manner as the embodiment described above, erroneous insertion of the second positioning pin 42 of the pressing member 40 and the third positioning pin 34 of the optical system 30 into the second and third positioning holes 213 and 214 of the heat radiator 20 can be suppressed or prevented.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1 Projector
3 Light source device
10 Light source
13 First positioning hole
20 Heat radiator
21 Heat radiation board
21a Placement surface
213 Second positioning hole
214 Third positioning hole
30 Optical system
31 Case
34 Third positioning pin
40 Pressing member
41 First positioning pin
42 Second positioning pin
50 Fixing member

What is claimed is:

1. Alight source device comprising:
a light source having at least a first positioning hole;
a heat radiator that has a placement surface on which the light source is placed, the heat radiator that has at least a second positioning hole on the placement surface;
a pressing member configured to press the light source against the placement surface; and
a fixing member that fixes the pressing member to the heat radiator, while the pressing member pressing the light source against the placement surface,
wherein the pressing member has at least a first positioning pin inserted into the at least first positioning hole of the light source, and at least a second positioning pin inserted into the at least second positioning hole on the placement surface of the heat radiator.

2. The light source device according to claim 1, wherein the heat radiator is free of a convex protruding from the placement surface.

3. The light source device according to claim 1, further comprising:
an optical system that processes the light emitted from the light source,
wherein the optical system has at least a third positioning pin inserted into a third positioning hole on the placement surface.

4. The light source device according to claim 3, wherein the second positioning hole and the third positioning hole are different from each other in at least one of size and shape in a view from the placement surface side.

5. The light source device according to claim 3, wherein the at least third positioning pin is a plurality of third positioning pins.

6. The light source device according to claim 1,
wherein the light source device comprises a plurality of light sources that comprises the light source,
wherein the pressing member is configured to press the plurality of light sources together against the placement surface, and
wherein the at least first positioning pin is a plurality of first positioning pins that correspond to the plurality of light sources, respectively.

7. The light source device according to claim 1, wherein the at least first positioning pin is hemispherically shaped.

8. The light source device according to claim 6,
wherein each of the plurality of light sources includes a respective substrate which has a respective set of the first positioning hole, and a respective set of light-emitting element on the substrate, and
wherein each of the plurality of first positioning pins has a radius that is smaller in dimension than a thickness of the respective substrate.

9. The light source device according to claim 1, wherein the pressing member is lower in thermal conductivity than the heat radiator.

10. The light source device according to claim 1,
wherein the light source device comprises a plurality of light sources,
wherein, for each of the plurality of light sources, the at least first positioning pin is a plurality of first positioning pins.

11. The light source device according to claim 1,
wherein the light source device comprises a plurality of light sources,
wherein the light source device comprises a plurality of sets of fixing members,
each set of the plurality of sets of fixing members correspond to a respective one of the plurality of light sources.

12. The light source device according to claim 11, wherein each set of the plurality of sets of fixing members penetrates a respective one of the plurality of light sources.

13. The light source device according to claim 11,
wherein, for the light source, the number of the plurality of first positioning pins is the same as the number of the plurality of fixing members, and
wherein, for the light source, each of the plurality of first positioning pins are positioned adjacent to a respective one of the plurality of fixing members.

14. The light source device according to claim 1, wherein the second positioning pin is positioned outside an area of the placement surface where the light source is placed on the area of the placement surface.

15. The light source device according to claim 1, wherein the at least second positioning pin is a plurality of second positioning pins.

16. A projector that has a light source device, the light source device comprising:
a light source having at least a first positioning hole;
a heat radiator that has a placement surface on which the light source is placed, the heat radiator that has at least a second positioning hole on the placement surface;
a pressing member configured to press the light source against the placement surface; and
a fixing member that fixes the pressing member to the heat radiator, while the pressing member pressing the light source against the placement surface,
wherein the pressing member has at least a first positioning pin inserted into the at least first positioning hole of the light source, and at least a second positioning pin inserted into the at least second positioning hole on the placement surface of the heat radiator.
